(19) United States
(12) Patent Application Publication
(10) Pub. No.: US 2001/0012387 A1
(43) Pub. Date: Aug. 9, 2001

(54) Process and system for the generation of diagnostic-quality three-dimensional ultrasound image data sets

(76) Inventor: Hans Polz, Wartenberg (DE)

Correspondence Address: BIERMAN MUSERLIAN AND LUCAS, 600 THIRD AVENUE, NEW YORK, NY, 10016

(21) Appl. No.: 09/740,389

(22) Filed: Dec. 19, 2000

(30) Foreign Application Priority Data
Dec. 21, 1999 (DE) 199 61 652.3
Feb. 3, 2000 (DE) 100 04 748.3

(51) Int. Cl. G06K 9/00

(52) U.S. Cl. 382/131

(57) ABSTRACT

The process and system generates three-dimensional ultrasound image data sets of diagnostic-quality. A distance sensor is attached to and used in conjunction with the ultrasound head to determine position information along with image information as the ultrasound head is moved along the surface of the patient.

The Invention pertains to a process according to preamble, patent claim 1 and to a system for implementation of this process according to preamble, patent claim 6. A process for recording diagnostic-quality three-dimensional ultrasound image data sets is already known and described, e.g., in FP 0 865 765. An essential aspect of this known process is for example the free guidance of the ultrasound head during the recording of the individual ultrasound images, i.e. during the image or data acquisition. For determining the position and orientation data in the known process, an electromagnetic sensor system is used, which is available, for example, under the designation “ISOTRAK II” from POLHEMUS, One Hercules Drive, Colchester, Vt. 05446.

The object of the invention is to improve a process and a system for the acquisition of diagnostic-quality ultrasound image data sets so as to enable, while preserving the free manual guiding of the ultrasound converter or the ultrasound head, a simplified design of this ultrasound head.

For the solution of this problem, a process corresponding to patent claim 1 is embodied. A system is embodied corresponding to patent claim 6.

Further embodiments of the invention are the subject of the dependent claims. The invention is described in more detail below using a sample embodiment in the figures, as follows:

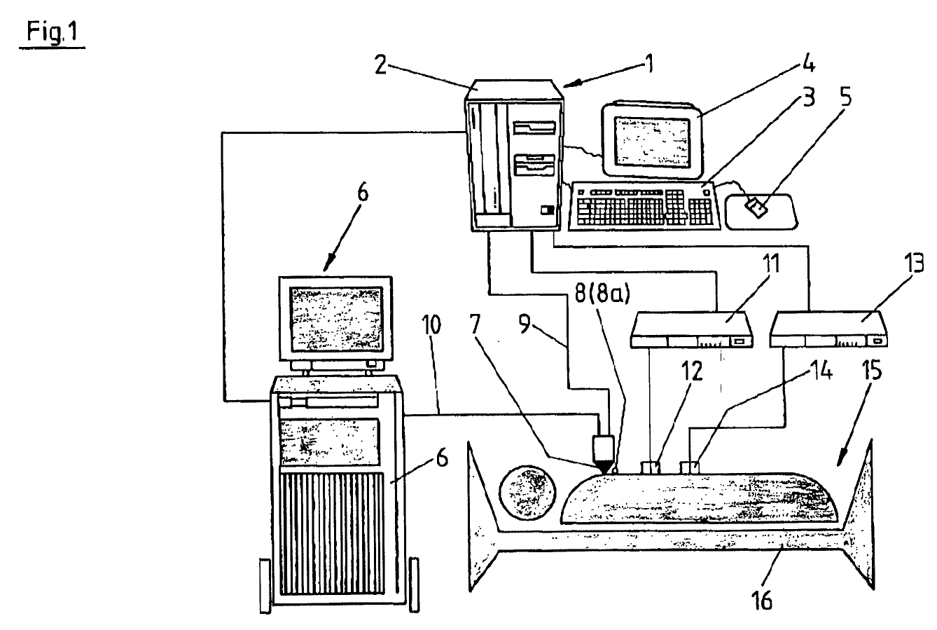

FIG. 1, a schematic representation of an embodiment of a system according to the invention for generating diagnostic-quality three-dimensional data sets for the tomographic imaging of a volume to be examined;

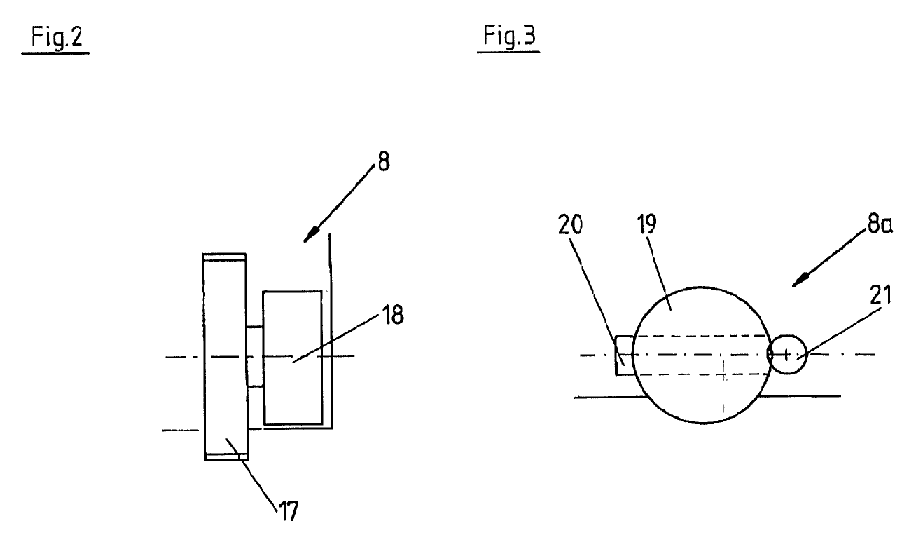

FIGS. 2-4, schematic representations of various possible embodiments of a distance sensor for use in the system of FIG. 1;

FIG. 5, a schematic representation of the single images stored in the image processing system, together with graphic representations of the EKG cycle and the respiration cycle of a patient.

The figures include 1 an image processing system, which essentially consists of the computer 2 and the peripheral equipment connected to it, such as keyboard 3, monitor 4, mouse control 5 etc. Allocated to the image processing system are:

an ultrasound device 6 with an ultrasound head 7 that can be freely moved or guided by the examining person and

an electrical or electronic distance sensor 8, 8a or 8b on the ultrasound head,

The ultrasound device 6 with the ultrasound head 7 is for example a device familiar to the expert that is used in medical diagnosis for recording ultrasound images that reproduce an area or section of the volume to be examined that is located in the image plane of the freely guided ultrasound head 7.

The distance sensor 8, 8a or 8b in the depicted embodiment is connected with the computer 2 via a line 9, whereby this signal line 9 is preferably located in a cable with the signal line 10 that connects the ultrasound head 7 with the ultrasound device 6. It is basically also possible, in particular in place of the line 9 to provide for a wireless transfer of the signals of the distance sensor 8, 8a or 8b to the computer 2, for example by means of a radio or infrared connection.

In the depicted embodiment the image processing system is also allocated an EKG device 11 with corresponding electrodes 12 and a device 13 for registering the breathing (respiration cycle) with corresponding probes 14, 15 designates a patient, whose body or partial body is a volume to be examined. The patient is located on a table 16.

The distance sensor 8/8a/8b located on the ultrasound head 7 is designed in such a way that upon contact with the outer surface of the volume to be examined, i.e. on the surface of the patient's body 15, it delivers a signal that corresponds to the movement or the path of the freely guided ultrasound head 7 in at least one movement axis that lies in a movement plane that forms a pre-defined angle with the plane of each single image delivered by the ultrasound head, for example an angle of 90°.

In a simplified embodiment it is possible that the distance sensor 8 records the movement only in one movement axis of the above movement plane. In this case, it is designed in such a way that the movement axis is perpendicular or crosswise to the image plane of the single images.

It is also basically possible, however, to design the distance sensor in such a way that it provides complete position and orientation information, i.e. not only the translation in one axis of the movement plane, but in each axis direction of this plane.

As depicted in FIG. 2, the distance sensor 8 consists for example of a small wheel 17 that is provided for on a converter 18 that converts the rotation of the wheel 17 into a signal proportionate to this rotation. The converter 18 is for example an analog angle sensor, e.g. potentiometer, the output voltage of which is digitalized by means of an analog-digital converter and transferred to the computer 2 by means of a serial port. If the input voltage of the angle sensor and the circumference of the wheel 17 are known, the translation of the displacement of the ultrasound head 7 in the respective movement axis can be determined. The rotation axis of the wheel 17 is parallel to an axis of the image plane of the respective single images produced by the ultrasound head.

To generate a volume data set by means of the computer 2 from the single images of the ultrasound head 7 and the signal of the distance sensor 8, the ultrasound head 7 must be oriented at the beginning of the examination, or at least at the beginning of the recording of the single images from which the volume data set is to be generated, in such a way that it is positioned upright at a pre-defined angle, for example perpendicular to the surface of the volume to be examined, that this orientation is maintained when moving the ultrasound head 7 along the surface of the volume to be examined and that the direction of movement remains essentially perpendicular to the axis of the wheel 17. During imaging, only a translation takes place, with no tipping of the ultrasound head 7.

Instead of the analog angle sensor, another sensor 18 can be provided for that delivers a signal in dependence on the rotation of the wheel 17, for example a sensor for production of a digital signal.

FIG. 3 shows a simplified representation of the distance sensor 8a, which can be used in place of the distance sensor 8 and which is capable of recording the two components of the respective movement extending perpendicular to each other in the movement plane and therefore the direction and the distance of movement in this movement plane. The distance sensor 8a is designed similar to a computer mouse with a rolling ball 19 that is driven by two small cylinders 20 and 21, the rotation axes of which are perpendicular to each other and in the movement plane. The rotation of the cylinders is converted into corresponding digital signals and transferred to the computer 2 as a distance sensor signal. The distance sensor 8a is then for example fastened to the ultrasound head 7 by means of a mount, so that the rolling ball 19 rolls on the surface of the volume to be examined when the ultrasound head 7 is moved on this surface and the two axes of the cylinders 20 and 21 lie in the movement plane, for example in such a way that one of the two axes lies parallel to one axis direction, i.e. to the horizontal axis direction of the image plane of the respective single image, while the axis of the other cylinder is oriented crosswise or perpendicular to this image plane.

In order to create a volume data set from the single images and the data of the distance sensor 8a, it is also necessary with the use of the distance sensor 8a, at least at the beginning of the recording of the single images used for the volume data set and during this recording, to maintain a pre-defined, upright orientation of the ultrasound head 7 in relation to the surface of the volume to be examined, for example a perpendicular orientation. During the imaging, therefore, only a translation of the ultrasound head 7 is possible, but no tipping of the ultrasound head 7.

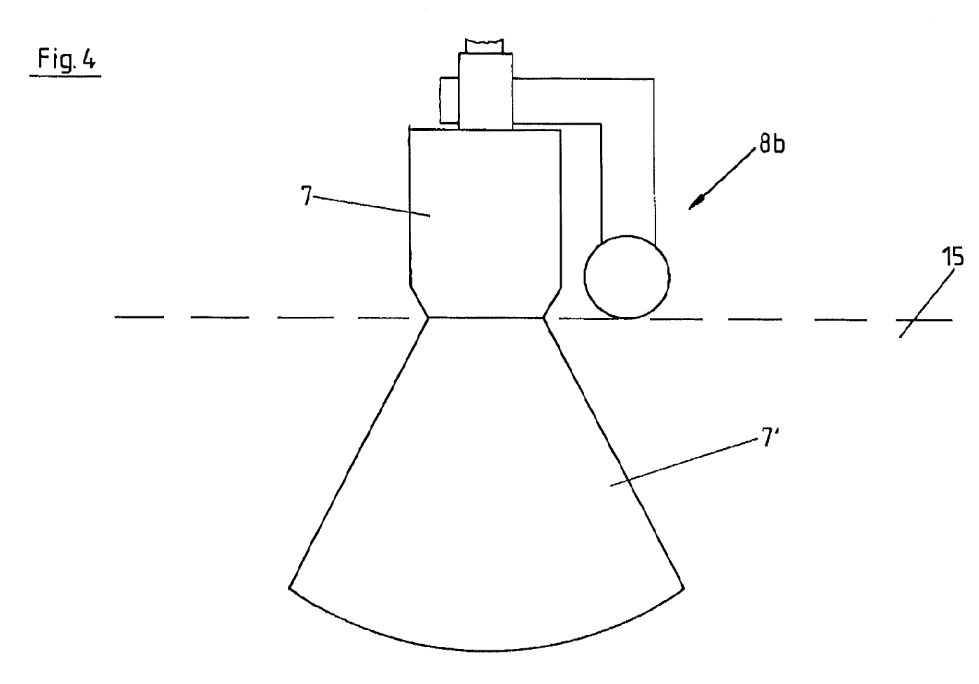

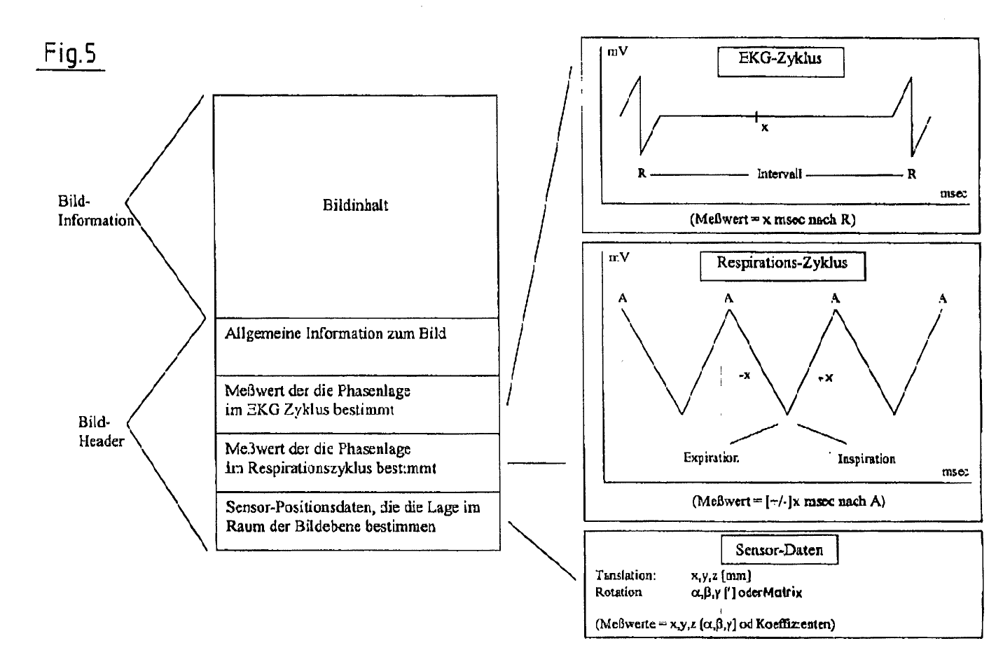

FIG. 4 again shows a simplified representation, in side view, of the ultrasound head 7, whereby 7′ suggests also the image plane of the ultrasound head that lies parallel to the plane of projection of FIG. 4. A distance sensor 8b is located on the ultrasound head 7 that is similar to the distance sensor 8 and also has a wheel 17 that works together with a converter 18 not depicted in FIG. 4. In deviation from the distance sensor 8, the distance sensor 8b is oriented in such a way that the axis of the wheel 17 is perpendicular to the image plane of the single images produced by the ultrasound head 7.

The distance sensor 8 therefore produces distance data that correspond to the movement of the ultrasound head 7 parallel to its image plane 7′. The distance sensor 8b is also especially suited for use in combination with the distance sensor 8, in order to produce distance data that correspond to a movement in a plane that is perpendicular to image plane 7′.

The EKG device 11 is like the ones familiar to an expert and used in medical practice and diagnosis and which deliver a variable voltage to an output in dependence on the EKG cycle. Device 13 is likewise a device that is familiar to an expert that is used in medical practice or diagnosis for recording the respiration cycle and delivers a variable voltage in dependency on this respiration cycle.

The following procedure is followed when recording the three-dimensional data set:

The single ultrasound images are recorded by the computer 2 of the image processing facility 1. Then, if the ultrasound device 6 provides analog images, these are digitalized. If the ultrasound device 6 already provides single images in digital form, then these can be recorded and processed by the computer 2 without being converted. In the computer 2 the signal of the distance sensor 8 or 8a is also recorded and stored in a data set allocated to the respective single image, for example in an image header of the data set that contains this image header and the image content. This takes place for example “online”, i.e. immediately during the image or data acquisition or after the image or data acquisition in a first step of subsequent processing. The image header also contains for example values of the EKG devise 11, e.g. a measured value that defines the phase position of the respective single image in relation to the EKG cycle, and/or e.g. a measured value of the device 13, which for example defines the phase position of the single image in relation to the respiration cycle, as depicted in FIG. 5. With the help of the signals of the distance sensor 8, 8a or 8b, the recording of the single images (image or data acquisition) by the system 1 or the computer 2 is controlled in such a way that single images provided by the ultrasound device 6 are accepted or stored only if the ultrasound head 7 was moved over a distance corresponding to the desired resolution which is preferably programmable or selectable in the system.

The signals delivered by the distance sensor 8, 8a or 8b are recorded and processed by the computer 2 in order to define at any time especially from these signals the position of the ultrasound head 7 in relation to an initial position.

If the distance sensor 8 is used, which provides the translation in only one axis direction, It Is assumed during the calculation of the position of the ultrasound head in the computer 2 that the ultrasound heart 7 was moved during the recording of the single images only in a straight line in this movement axis perpendicular or crosswise to the image plane.

If die distance sensor 8a or the combination of the distance sensor 8 and 8b is used, signals delivered by this distance sensor are used to calculate at any time the position and also the actual orientation of the ultrasound head 7, taking into account the instruction for guiding this ultrasound head (only translation movements— no tipping or rotating movements).

The allocation of the single ultrasound images and the position date takes place for example by means of a work cycle or time cycle of the computer 2.

The image data stored in the computer 2 with the corresponding image headers form a rough data set in which especially when the distance sensor 8a is used the image levels of the single images can be oriented differently. From this rough data set, the diagnostic quality three-dimensional data set is created, for example by a transformation or interpolation process, in a standard reference or coordinate system. To do this, the method described in detail in EP 0 865 765 can be followed, for example.

The EKG device 11 and the device 13 make it possible to generate dynamic or static three-dimensional data sets, with respect to the heart cycle or the respiration of the patient 15. In particular, this enables EKG triggering during the image or data acquisition by the computer 2.

1. Process for generating a diagnostic-quality three-dimensional image data set using an ultrasound device (6) with a freely guidable ultrasound head (7) for producing a sequence of single ultrasound images in various planes of the volume to be examined, using an image processing facility (1) to which the single ultrasound images are transferred and using at least one position sensor (8, 8a, 8b) that defines at least the position of the ultrasound head and therefore the position of the image plane of the respective generated ultrasound image, the data of which are also transferred to the image processing facility (1), which generates a three-dimensional volume date set for tomographic recording of the examined volume from the image data of the single ultrasound images and the position data, characterized in that the position sensor element is a distance sensor (8, 8a, 8b) that is attached to the ultrasound head (7) and that is moved with the ultrasound head (7) along the surface of the volume to be examined bearing on this surface.

2. Process according to claim 1, characterized by the use of at least one distance sensor (8, 8b) that records only the translation movement in one axis direction.

3. Process according to claim 2, characterized by the use of a distance sensor (8) that records the translation movement in one axis direction crosswise or perpendicular to the image plane of the ultrasound head (7).

4. Process according to claim 2 or 3, characterized by the use of a distance sensor (8b) that records the translation movement in one axis direction parallel or approximately parallel to the image plane of the ultrasound head (7).

5. Process according to one of the claims 1 through 4, characterized by the use of a distance sensor (8a) that records the translation movement in two directions of movement extending perpendicular to each other.

6. System for generating a diagnostic-quality three-dimensional image data set with an ultrasound device (6) with a freely guidable ultrasound head (7) for producing a sequence of single ultrasound images in various planes of the volume to be examined, with an image processing facility (1) to which the single ultrasound images are transferred and with at least one position sensor (8, 8a, 8b) that defines at least the position of the ultrasound head and therefore the position of the image plane of the respective generated ultrasound image, the data of which are also transferred to the image processing facility (1), which generates a three-dimensional volume data set for tomographic recording of the examined volume from the image data of the single ultrasound images and the position data, characterized in that the position sensor is a distance sensor (8, 8a, 8b) that is attached to the ultrasound head (7) and that is moved with the ultrasound head (7) along the surface of the volume to be examined bearing on this surface.

7. System according to claim 6, characterized by at least one distance sensor (8, 8b) that records only the translation movement in one axis direction.

8. System according to claim 7, characterized by a distance sensor (8) that records the translation movement in one axis direction crosswise or perpendicular to the image plane of the ultrasound head (7).

9. System according to claim 7 or 8, characterized by a distance sensor (8b) that records the translation movement in one axis direction parallel or approximately parallel to the image plane of the ultrasound head (7).

10. System according to one of the claims 6 through 9, characterized by a distance sensor (8a) that records the translation movement in two directions of movement extending perpendicular to each other.
